(19) United States
(12) Patent Application Publication
(10) Pub. No.: US 2023/0094284 A1
(43) Pub. Date: Mar. 30, 2023

(54) SYSTEM AND METHOD FOR DISTRIBUTION OF PAYMENTS FROM PAYROLL

(71) Applicant: Brightside Benefit, Inc., San Francisco, CA (US)

(72) Inventors: Callum Lachlan KING, San Francisco, CA (US); Jacky Yuk Ming CHIU, Chandler, AZ (US)

(21) Appl. No.: 18/077,202

(22) Filed: Dec. 7, 2022

Related U.S. Application Data
(63) Continuation-in-part of application No. 16/773,816, filed on Jan. 27, 2020.
(60) Provisional application No. 62/798,882, filed on Jan. 30, 2019.

(51) Int. Cl. G06Q 40/00

(52) U.S. Cl. CPC G06Q 40/125

(57) ABSTRACT

A method for generating financial propensity outcomes using a machine learning model. The method may include receiving internal data on a client, the internal data comprises transactional data, behavioral data, demographic data, credit data, and communication data; receiving external data, the external data comprises publicly available data; training the machine learning model using historical financial data to model forecasts and predictive analytics; deploying the trained machine learning model and providing the internal data and the external data as data input to the trained machine learning model; and generating the financial propensity outcomes associated with the client from the trained machine learning model through forecasts and predictive analytics.

### CROSS-REFERENCE TO RELATED APPLICATIONS

This application is a Continuation-In-Part of U.S. application Ser. No. 16/773,816, filed on Jan. 27, 2020, the entire contents of which is incorporated herein by reference, which claims priority under 35 U.S.C. 119(a) to U.S. Provisional Application No. 62/798,882, filed on Jan. 30, 2019, the entire contents of which is also incorporated herein by reference.

### BACKGROUND

### Field

The present disclosure relates to payroll distribution, and more specifically, to systems and methods for automatically distributing payroll payments to partners based on instructions provided by employees.

### Related Art

Many employees use automatic debits or electronic payments from their bank accounts to pay recurring bills such as loan payments, utility bills, savings account/retirement account contributions, etc. Further, many employees of the same employer may be making these automatic debits or electronic payments to the same end parties (e.g., same loan holder, same utility company, same savings/retirement account manager, etc.). This situation may result in an inherent inefficiency of transactions with all of the funds starting out in a single employer's payroll distribution, being transferred to individual employee's bank accounts, and transferred from multiple employees' bank accounts into the same account held by the end party (e.g., same loan holder, same utility company, same savings/retirement account manager, etc.). Each such transfer may have potential transfer fees and other costs (both monetary and non-monetary costs, such as transaction tracking costs). Existing payroll management systems do not provide any mechanisms that could address these inherent inefficiencies.

### SUMMARY OF THE DISCLOSURE

Aspects of the present application may provide is a system that enables a flow of funds that that allows a platform provider to receive funds from one place (e.g., an employer) on behalf of a set of entities (employee) and then distribute those funds to another set of entities (end payees, herein called “partners”) and then have the entities (“partners) be paid with an individual lump sum with the platform returning any remainder back to the employee.

Aspect of the present disclosure involves an innovative method for generating financial propensity outcomes using a machine learning model. The method may include receiving internal data on a client, the internal data comprises transactional data, behavioral data, demographic data, credit data, and communication data; receiving external data, the external data comprises publicly available data; training the machine learning model using historical financial data to model forecasts and predictive analytics; deploying the trained machine learning model and providing the internal data and the external data as data input to the trained machine learning model; and generating the financial propensity outcomes associated with the client from the trained machine learning model through forecasts and predictive analytics.

### BRIEF DESCRIPTION OF THE DRAWINGS

FIG. 1 illustrates a flow chart of payment distributions generally in accordance with example implementations of the present application.

FIGS. 2 and 3 illustrate flow charts of a process for payment distributions based on employee instructions in accordance with example implementations of the present application.

FIG. 4 illustrates a schematic representation of a payment distribution system in accordance with example implementations of the present application.

FIG. 5 illustrates a payment and data flow diagram in accordance with Example implementations of the present application.

FIG. 6 illustrates an example client intelligence engine, in accordance with an example implementation.

FIG. 7 illustrates an example diagram showing inputs and outputs of the client intelligence engine, in accordance with an example implementation.

FIG. 8 illustrates an example computing environment with an example computer device suitable for use in some example implementations.

FIG. 9 illustrates an example customer relationship management (CRM) display visualizing actionable insights in association with customer conversation, in accordance with an example implementation.

FIG. 10 illustrates an example CRM display visualizing client/employee profile, in accordance with an example implementation.

FIG. 11 illustrates an example application display visualizing notifications and actionable items on the end of a client/employee, in accordance with an example implementation.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application. Further, sequential terminology, such as “first”, “second”, “third”, etc., may be used in the description and claims simply for labeling purposes and should not be limited to referring to described actions or items occurring in the described sequence. Actions or items may be ordered into a different sequence or may be performed in parallel or dynamically, without departing from the scope of the present application.

In the present application, the terms computer readable medium may include a local storage device, a cloud-based storage device, a remotely located server, or any other storage device that may be apparent to a person of ordinary skill in the art.

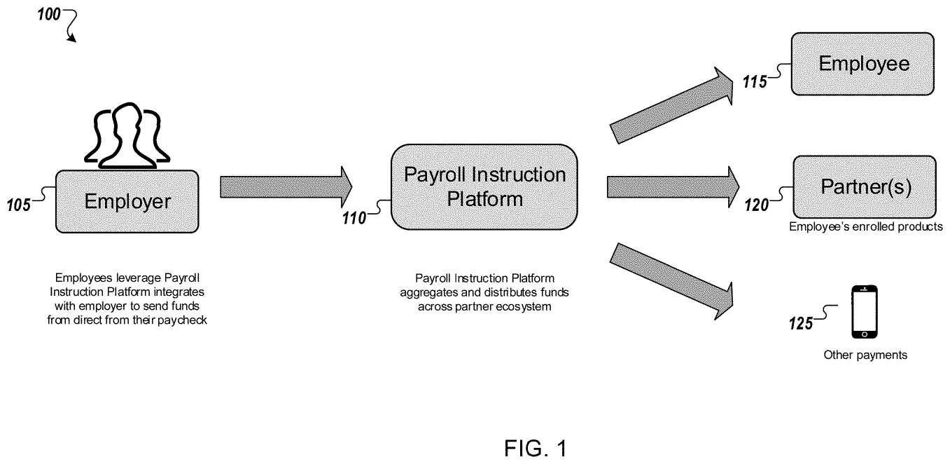

FIG. 1 illustrates a flow chart 100 of payment distributions generally in accordance with example implementations of the present application. As illustrated, the payroll platform may provide the ability for an employer 105 to have one lump sum sent to the platform infrastructure 110, for example at a paycheck period, then through the employer's instructions, allocate the lump sum into custody accounts associated with individual employees 115. Further, the platform may allocate funds from the custody accounts associated with the employees to custody accounts associated with partners 120 (end payees) and other payment plans 125, based on previously received instructions from the employees. Finally, once all of the funds to be allocated based on the employee instructions have been allocated, the platform would send the allocated funds from each partner custody account to the partner's actual underlying bank account. Further, in some example implementations, any unallocated funds (e.g., funds in excess of the specific allocation instructions provided by the client) remaining in the custody accounts associated with individual employees are transferred to the individual employee's personal bank accounts. In other words, once the funds the employees have instructed to be allocated to the partners have been transferred, all remainder funds are returned to the employees. For purposes of illustration, more detailed examples are discussed below and illustrated in the attached figures.

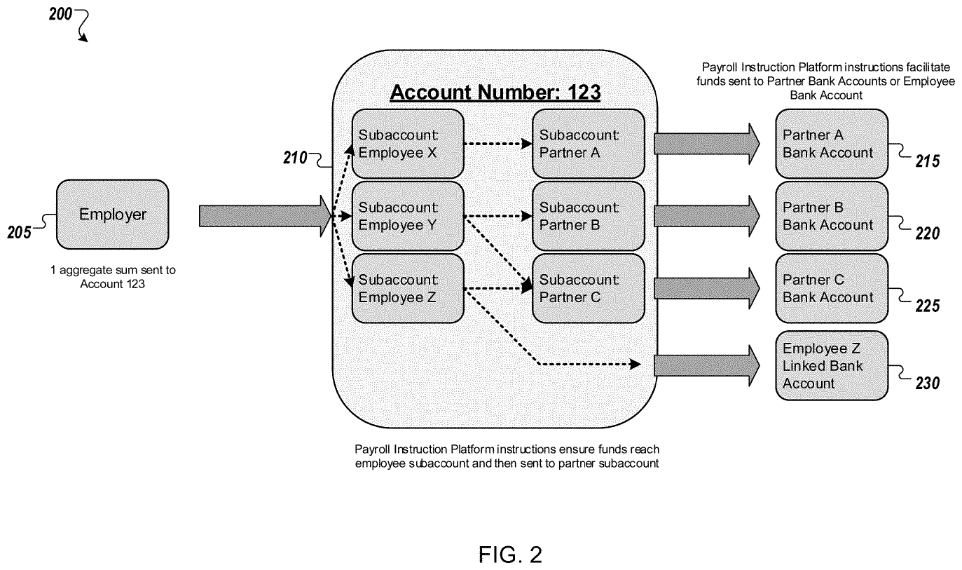

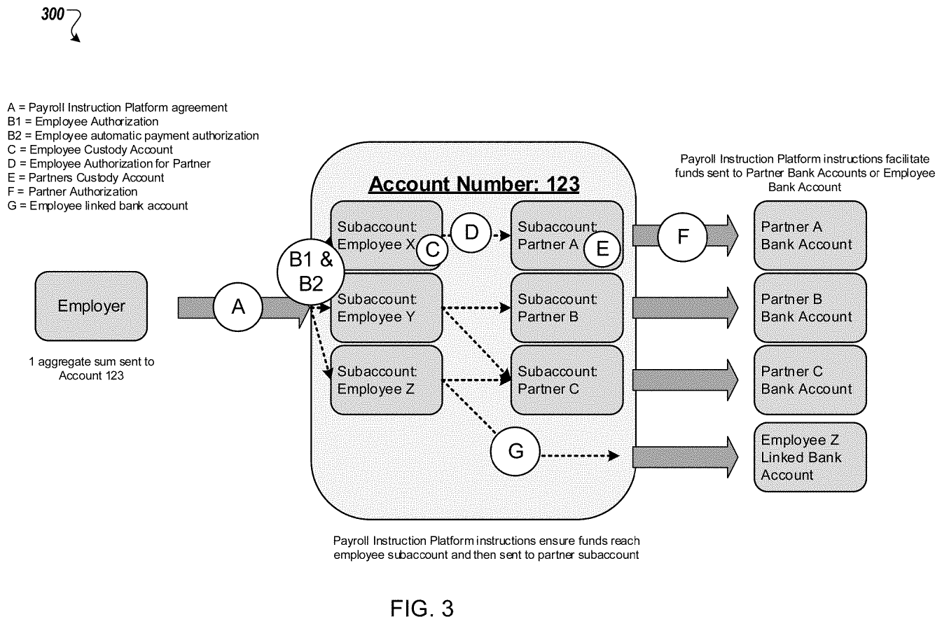

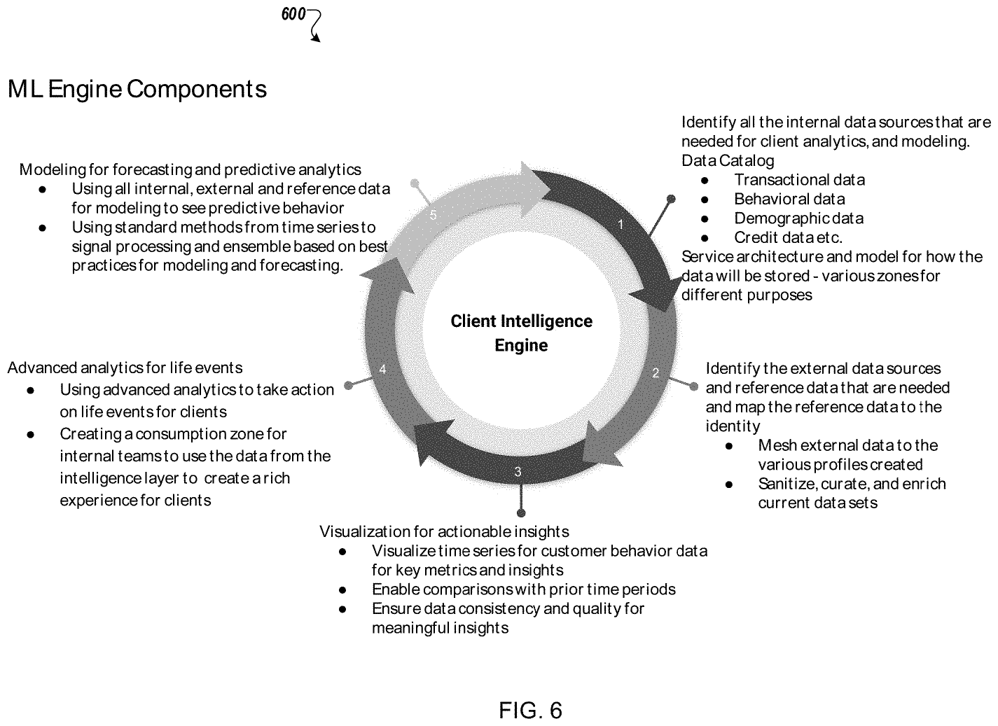

FIGS. 2 and 3 illustrate flow charts of a process 200, 300 for payment distributions based on employee instructions in accordance with example implementations of the present application. In the illustrated examples, the platform may be implemented by one or more computing devices, such as computing device 805 of the computing environment 800 discussed below with respect to FIG. 6.

As illustrated in FIGS. 2 and 3, an employer 205 may have three employees (X, Y, and Z). From the Employer's lump sum payroll transfer, each employee's paychecks are allocated into a subaccount 210 associated with each employee. Based on instructions provided by each employee, the platform may deduct a defined amount (e.g., $25) from each employee's paycheck and send those $25 to different partners (Partners A, B, and C, shown at 215, 220, 225, 230). For example, Employee may send $75 in one lump sum to the payroll infrastructure. The payroll infrastructure would split that $25 and put it into each employee's own custody account. Then, that $25 would get allocated to another custody account associated with a partner. For example, Employees Y and Z, may both choose $25 payments are going to one partner (Partner C), and for that one partner, $50 may be allocated to Partner C's subaccount. Once all of the allocations of the payroll from the lump sum received from the employer have been completed, the platform will send that $50 in Partner C's subaccount to Partner C's actual bank account to receive those funds.

Thus, the payroll infrastructure has facilitated one lump sum coming out of an employer's payroll on behalf of multiple employees to end up in a multitude of different partners and bank accounts. Further, the platform provider has not actually taken ownership of those funds, which were held in custody account infrastructure that has been put in place. Instead, the platform has merely provided allocation instructions to processors at a bank that is managing the custody account associated with the employer.

Further, in some example implementations, one or more employees may elect to have more than their expected partner allocated transferred to their custody account. In such implementations, the funds in excess of the allocations may be transferred to a linked bank account specified by the employee (e.g., the employee's personal bank account). For example, Employee Z may specify that any excess funds in his or her custody account be transferred to the linked bank account they have identified (e.g., Employee Z's personal checking account).

As illustrated in FIG. 3, the employer may enter into a payroll instruction platform agreement A with the payroll instruction platform provider to provide the funds distribution capability. Further, each employee may provide authorizations B1, B2 to participate on the platform and to automatically make payments to and from their paycheck into their custody account C. Specifically, each employee may provide an authorization B1 to participate in the payroll instruction platform and an automatic payment authorization B2 to authorize payments be sent to one or more partners. Based on the employee's authorizations D for respective partners, the platform will distribute the funds from the employee custody account C to the partner custody account E. Further, the platform will distribute funds from the partner custody account E to the Partner's bank account based on a partner authorization F. Finally, if there are any excess funds in any of the employee's custody account after the distributions authorized with the employee authorizations D, the payroll instruction platform will distribute the excess funds to each employee's linked bank account G.

In some example implementations, the custodian accounts C and E associated with one or more of the individual employees and individual partners may be subaccounts with the employer's payroll account. In other example implementations, the custodian accounts C and E associated with one or more of the individual employees and individual partners may be completely separate accounts at the same financial institution.

As described above, in some example implementations, an employee may specify more than their anticipated partner payments, or even the entire paycheck of said employee be processed through the platform. In such example implementations, any remainder in the individual employee's custodian account may be distributed to the employee's regular banking account once all partner allocations and distributions have occurred. In other example implementations, only a portion of the employee's paychecks that is anticipated to be distributed to the partners may be processed through the platform. For example, each employee may specify a specific amount or percentage from their paychecks to be distributed through the platform, with the remainder of the paycheck being distributed to the employee's bank account independent of the payroll instruction platform.

Further, in some example implementations, the subaccounts associated with the employee may be specific to the employee such that if any employee has multiple jobs, each registered with the platform, the employee may have only a single subaccount on the platform. Similarly, the subaccounts associated with the partner may be specific to the partner such that if each partner may have only a single subaccount on the platform for all employers and employees registered with the platform. For example, a utility provider may have a single subaccount that receives allocations from multiple employees associated with different employers on the platform.

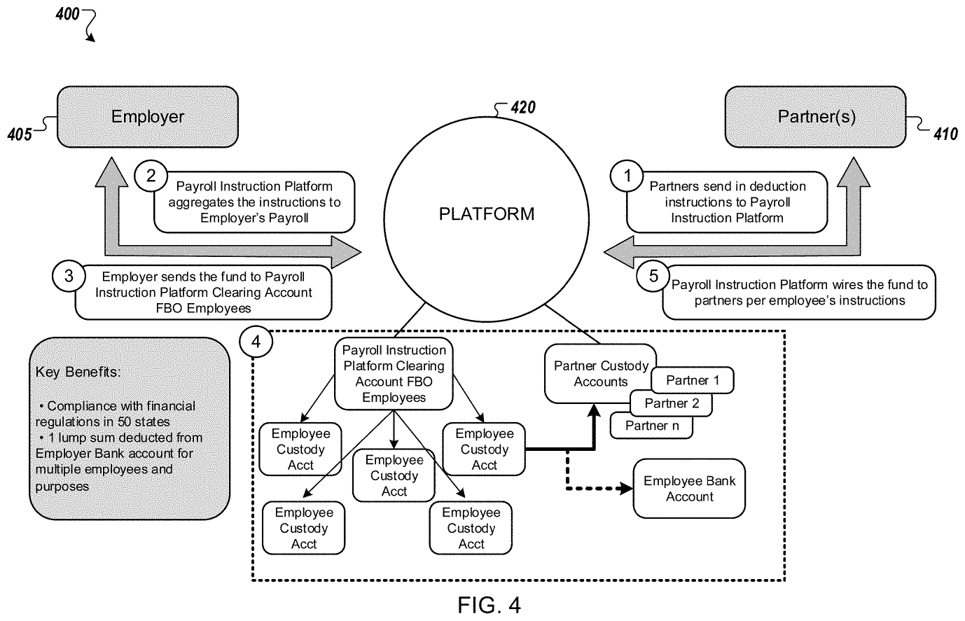

FIG. 4 illustrates a schematic representation of a payment distribution system in accordance with example implementations of the present application. In the illustrated examples, the system may be implemented by one or more computing devices, such as computing device 805 of the computing environment 800 discussed below with respect to FIG. 6.

As illustrated in the flowchart 400 shown in FIG. 4, the partners 410 send in deduction and payment instructions to the platform 420 through flow 1. Platform aggregates instructions for the employer's 405 payroll distribution received through flow 2. During each payment cycle, the employer sends funds to the platform clearing account for the benefit of the employer's employees through flow 3. During flow 4, the platform distributes the received funds to the employee's clearing accounts, and allocates funds from the employee's clearing accounts to partner custody accounts based on employee provided authorizations. Any excess funds not allocated to any partner custody accounts may be distributed to the employee's personal bank account. Finally, the platform wires funds from the partner's custody accounts to the partner's bank accounts based on the employee's instructions at flow 5.

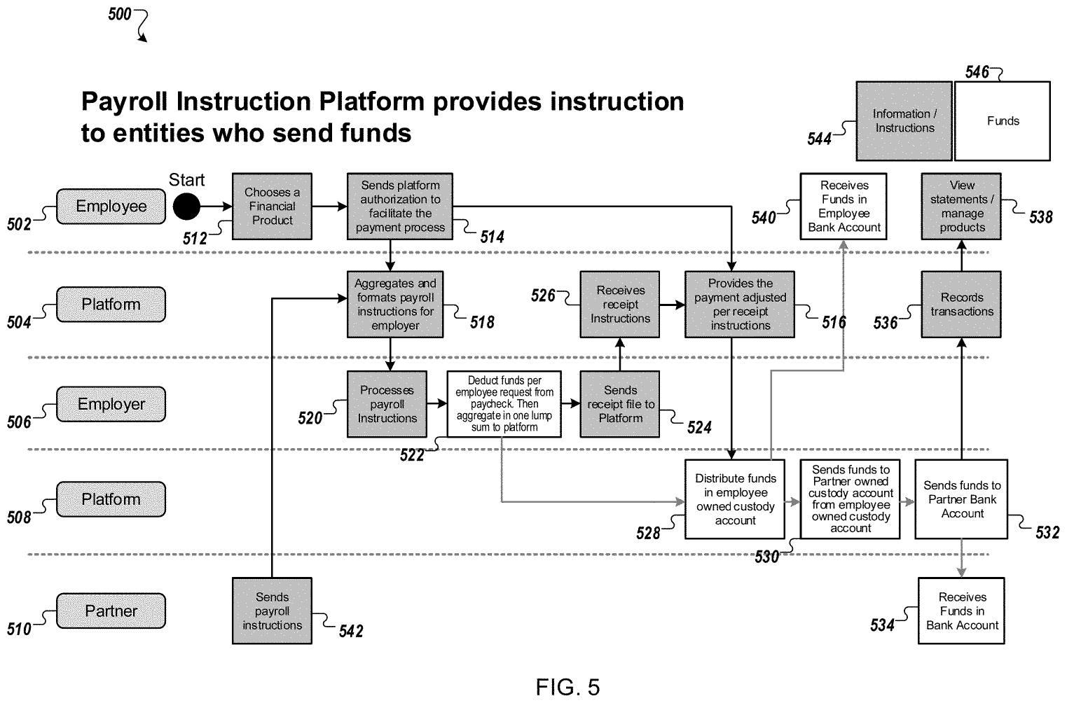

This platform system may have the benefit of complying with current financial regulations in 50 states because the platform does not ever take possession of the funds and the platform does not exhibit any control over the funds. Instead, it simply executes instructions provided by the employee's and partners based on the employee's and partner's authorizations. This is further illustrated in FIG. 5 below. Additionally, this system may also allow a single, lump sum from the employer's bank to deduct from the Employer's account on behalf of multiple employees and distributed for multiple purposes (e.g., payments to multiple partners).

FIG. 5 illustrates a payment and data flow diagram in accordance with Example implementations of the present application. In the illustrated examples, the system may be implemented by one or more computing devices, such as computing device 805 of the computing environment 800 discussed below with respect to FIG. 6.

As illustrated in FIG. 5, grey boxes are representative of instructions or authorizations 544 distributed between the involved parties. Further, white boxes are representative of funds 546 transferred between the involved parties. As the white boxes illustrate, funds are transferred from the employer to a custodian bank associated with the platform, but are not under the platform's possession or control. These funds are then distributed to employee owned custody accounts, allocated from the employee owned custody accounts to provider owned custody accounts, and the transferred either to the partner's bank account or the employee's personal bank account. Ownership of the funds is never transferred to the platform.

As shown in FIG. 5, an employee 502 may choose a financial product at 512. Then, once the financial product is chosen, the platform authorization is sent at 514 to facilitate the payment process. Then, at 516, the platform may aggregate and format payroll instructions for the employer, and provide the payment adjusted per receipt instructions. Simultaneously, at 542, a partner may send payroll instructions, which may then be aggregated and formatted for the employer 506 via the platform 504 at 518.

Once the platform aggregates or formats payroll instructions for the employer at 518, the employer 506 may then process the payroll instructions at 520, deduct funds per the employee's 502 request from the paycheck and aggregate the funds into one lump sum to the platform at 522, and send the receipt file to the platform at 524.

At 526, the platform 504 may then receive receipt instructions from 524, and provide the payment adjusted amount per received instructions, at 516.

From 522 or 516, the platform 508 may distribute funds in the employee-owned custody account at 528. Then, the platform may either send the funds to the partner-owned custody account from the employee-owned custody account at 530, or the employee may receive the funds in the employee Bank Account at 540. Platform 508 may be the same platform as platform 504 in some example implementations. In other example implementations, separate platforms may be used such as illustrated in FIG. 5 to more clearly demonstrate the flow of data. In some example implementations, 524 and 528 may occur simultaneously after 522 has been completed.

After the funds are sent to the partner-owned custody account at 530, the platform 504, 508 may then send the funds to the partner Bank Account at 532. Then, at 534, the funds may be received in the partner 510 Bank Account at 534. Simultaneously, the platform 504, 508 may record transactions at 536. For example, once the fund transfer gets initiated at 532, the platform 504 records the transaction at 536. Then, the platform 508 may check the status of the fund to ensure completion of the process (e.g., that the funds are received in the bank account at 534).

If the platform 504 records the transactions at 536, then the employee 502 may view the statements and manage the products at 538. The products may include, but are not limited to, payroll-linked savings, emergency loans, personal loans, and other similar products of this type. The employee 502 may see the completed transactions in an application such as a mobile application that feeds from the platform's API.

In some example implementations, steps 514-516 may be performed optionally. Further, in some example implementations, 530 and 516 may be performed simultaneously after step 522 has been performed. Thus, an employee may designate the fund distributes to partner(s) based on their selected product(s) and/or their own account.

In a case where there is a failure in advancing to a next step shown in the flow chart, the platform will attempt to repeat the failed step or create an exception for that step in the process.

Data/information associated with the instructions and transaction processes as illustrated in FIG. 5 are recorded and form a part of internal data, which will be described in more details below.

FIG. 6 illustrates an example client intelligence engine 600, in accordance with an example implementation. Information/data such as, but not limited to, demographic data, employment/salary data, payroll deductions, credit history, financial transactions monitoring data, cash flow data, banking data, data on enrolled financial products, communication data, public data, etc., serve as input to the client intelligence engine 600. The client intelligence engine 600 is a machine learning/artificial intelligence engine that models financial forecasting and predictive analytics using a client/employee's financial data and external data, and determines financial propensity outcomes associated with the client/employee.

As illustrated in FIG. 6, there are five steps to the client intelligence engine 600. At the first step, internal data from internal data sources are obtained for the purpose of client analytics generation and modeling. Internal data may include data such as, but not limited to, transactional data, behavioral data, demographic data, credit data, communication data, etc., as part of the input data mentioned above. Communication data may include phone/messaging conversations initiated by the client/employee to engage financial service providers or financial assistants associated with services provided as part of the client intelligence engine 600 or the payroll instruction platform of FIG. 5. In some example implementations, internal data such as, but not limited to, employees' demographic information, personally identifiable information (PII), employment history, benefits selections, 401K information, etc., may be provided by the employer. Together, internal data generated from the different internal data sources form the client/employee profiles.

At the second step, external data sources and associated reference data are identified, and external/public data are obtained as additional input to the client intelligence engine 600. The obtained external/public data are meshed to the various client/employee profiles (e.g. internal data) to sanitize, curate, and enrich the current data sets. In some example implementations, the client/employee profiles are generated as part of the payroll instruction platform of FIG. 5.

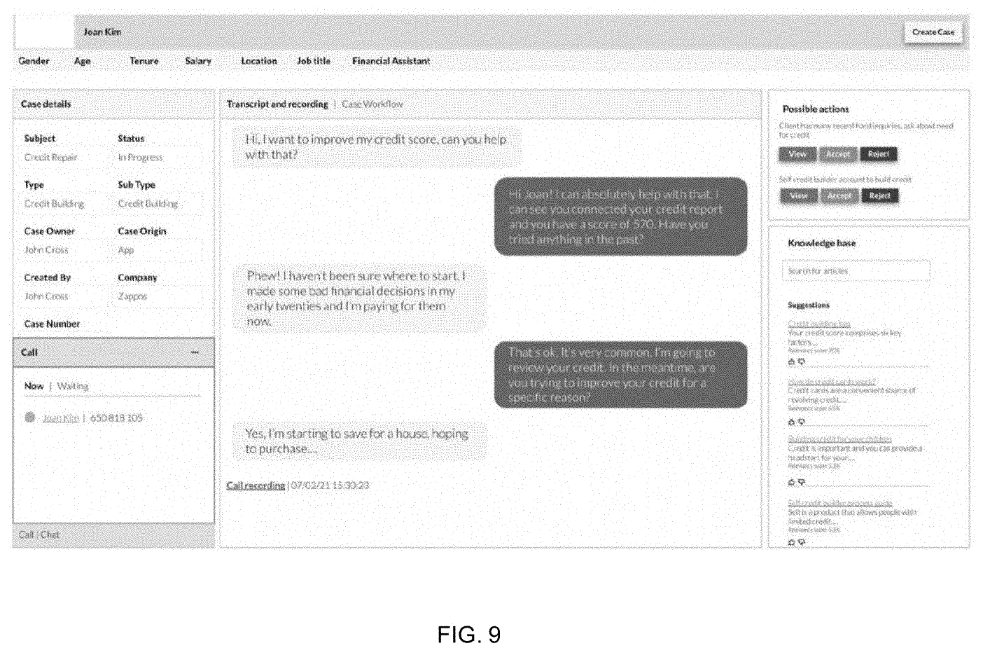

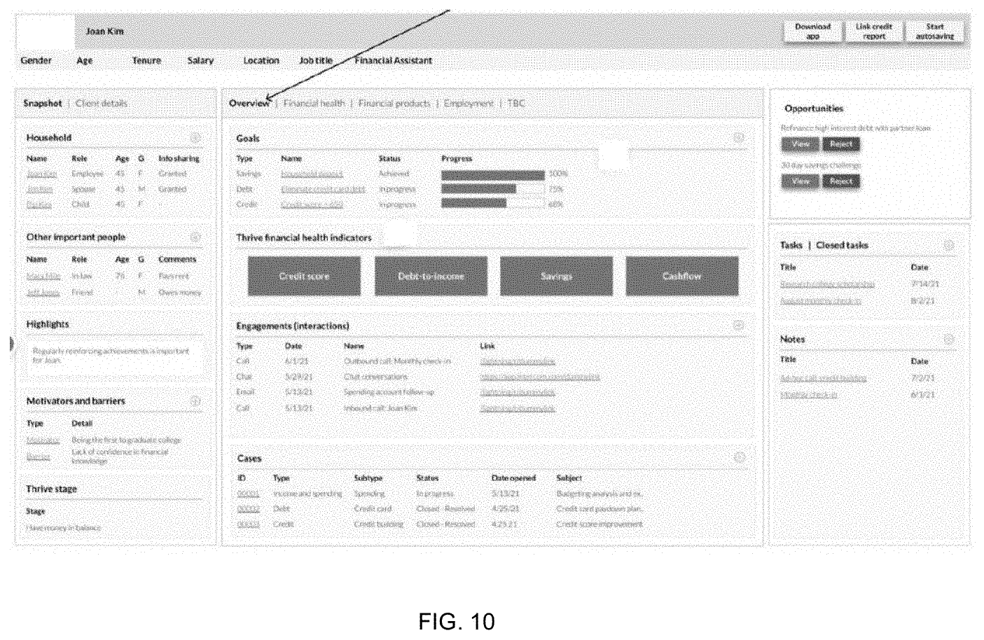

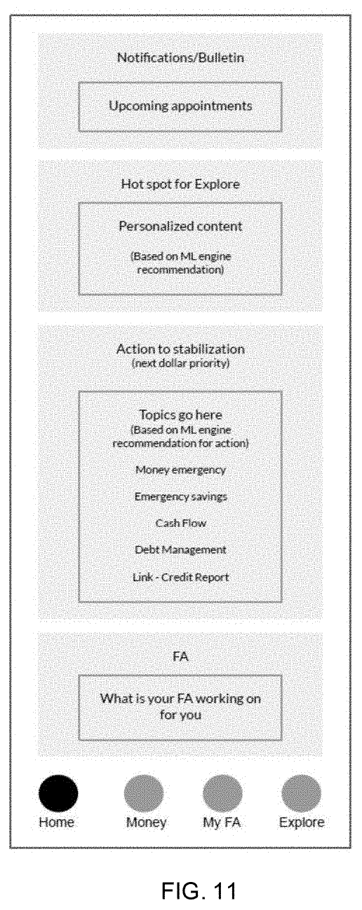

At the third step, actionable insights are visualized using the internal and external data. FIGS. 9-10 illustrate example displays visualizing actionable insights. FIG. 9 illustrates an example customer relationship management (CRM) display visualizing actionable insights in association with customer conversation, in accordance with an example implementation. As illustrated in FIG. 9, communications between client/employee and the financial assistant are monitored and stored to be used as part of machine learning. In addition, possible actions are generated and presented to the financial assistant to present to the client/employee. FIG. 10 illustrates an example CRM display visualizing client/employee profile, in accordance with an example implementation. As illustrated in FIG. 10, details pertaining to client/employee are populated as client/employee profile and available actionable opportunities are provided to financial assistant based on client/employee profile and external data. FIG. 11 illustrates an example application display visualizing notifications and actionable items on the end of a client/employee, in accordance with an example implementation. As illustrated in FIG. 11, various actionable items are available for the client/employee to choose from. Additionally, notifications may be provided to alert the client/employee of any pending actions or items requiring immediate attention.

Key metrics and actionable insights are visualized in time series based on behavioral data. Visualization of actionable insights allows for comparisons against past behavioral data observed in prior periods to detect noticeable data inconsistencies and sudden behavioral changes. Inputs and selected actions from financial analyst and client/employee are stored as part of internal data and used to fine tune the client intelligence engine 600's machine learning model. For example, person A and person B may have similar job and are similarly situated financially. However, their decisions on actionable insights/recommendations may differ significantly. Hence, their decision-making, as feedback loop, can greatly enhance the machine learning data model. Additionally, this ensures data quality for meaningful insights. In some example implementations, alerts are generated if the inconsistencies or sudden changes in behavior exceed predetermined safety/risk thresholds.

At the fourth step, advanced analytics are generated for client/employee's life events. In some example implementations, the client/employee's life events are provided by the client/employee's employer. Examples of life events may include, but not limited to addition of a family member, divorce, home ownership, use of family and medical leave, etc. Taking home ownership as example, such information and associated credit data (e.g. new trade lines for mortgage or refinancing) are reflected in the received data. At the fifth step, modeling is performed to model forecasts and predictive analytics. Internal data, external data, and reference data are provided as input to a trained machine learning model for predictive behavior modeling.

Steps one through five are performed iteratively to ensure any changes in data input is monitored and tracked, which can then be used in generating recommendations or predictions that reflect the observed changes.

Model training of the client intelligence engine 600 can be performed using historical data to generate a machine learning model that best generalizes relationships between input variables and dependent variables of the historical data. On completion of training, the trained machine learning model is then deployed in the client intelligence engine 600 for receiving real time data input and generating propensity outcomes associated with forecasts and predictions. Client/employee's decision on the recommendations generated by the client intelligence engine 600 is collected and used in the continuous fine-tuning of the machine learning model.

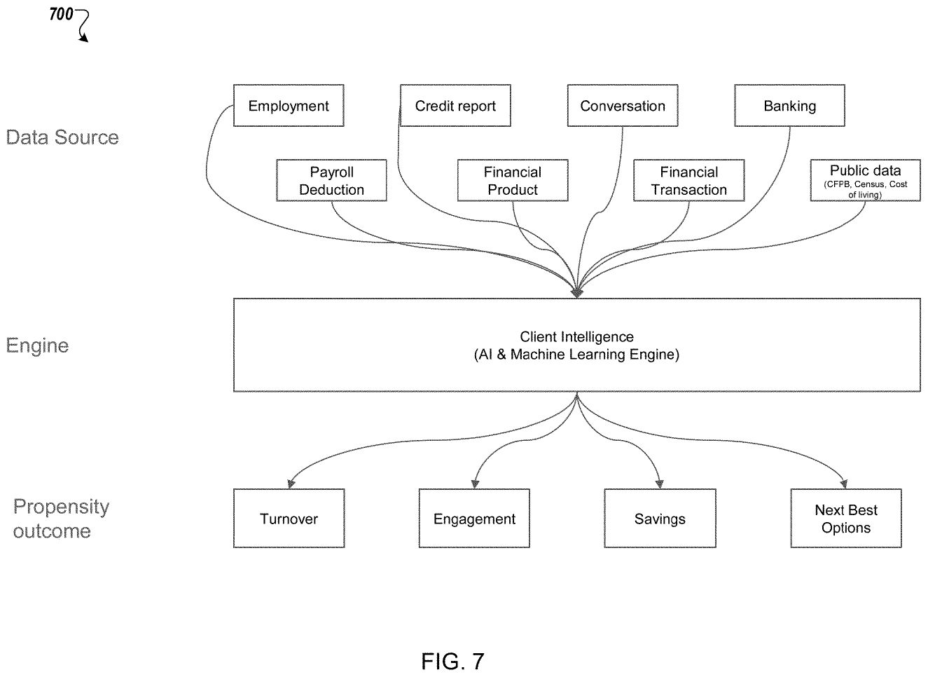

FIG. 7 illustrates an example diagram showing inputs and outputs of the client intelligence engine 600, in accordance with an example implementation. As illustrated in FIG. 7, inputs to the client intelligence engine 600 may include, but not limited to, demographic data, employment/salary data, payroll deductions, credit history/report, financial transactions monitoring data, cash flow data, banking data, data on enrolled financial products, communication data, public data, etc. Payroll deductions data associated with employees utilizing the payroll instruction platform can be obtained through recorded payroll deduction transactions. Public data may include data such as, but not limited to, data generated by the Consumer Financial Protection Bureau (CFPB), census data, data on cost of living, etc.

As illustrated in FIG. 7, on receiving data input from the various data sources, the client intelligence engine 600 then generates propensity outcomes such as, but not limited to, turnover, engagement, savings, next best options, etc. Under the propensity outcome of turnover, the client intelligence engine 600 can predict whether the client/employee is likely to leave the employer based on payroll deduction activities, credit history, and communication data. In some example implementations, the client intelligence engine 600 can estimate the number or percentage of employees likely to leave the employer based on payroll deduction activities, credit history, and communication data, when a large number of employees of the employer engage in use of the payroll instruction platform of FIG. 5. The client intelligence engine 600, in turn, can assist the employer's human resource team in managing the turnover risk and provide better financial health outcomes for employees.

Under the propensity outcome of next best options, the client intelligence engine 600 generates one or more of at least one of available financial recommendation or financial assistance option to help assist with the client/employee's financials. For example, financial recommendations and assistance options may include savings plans or packages specifically designed for the client/employee, available public assistance programs, etc.

In addition to payroll deduction services, financial specialist/assistance services are also available to clients/employees. Under the propensity outcome of engagement, the client intelligence engine 600 estimates an amount of time that a client or employee engages a financial specialist or financial assistant for service provision. In some example implementations, propensity for reengagement with a financial specialist or financial assistant is also estimated by the client intelligence engine 600.

Under the propensity outcome of savings, the client intelligence engine 600 can predict savings behavior of client/employee based on data input. Specifically, the client intelligence engine 600 predicts changes in savings behavior through observable changes in financial situations. For example, increased spending or payroll deductions to partners result in decreased savings for a client/employee. In some example implementations, if a noticeable trend persists or if a client/employee's current savings rate falls below a savings threshold, the client intelligence engine 600 provides at least one of alert notifications or recommended actions to the client/employee. In some example implementations, the savings threshold is predetermined by the client/employee or service operator operating the client intelligence engine 600. Provision of the alert notifications or recommended actions can be made through communication channels such as, but not limited to, text messages, emails, application notifications, automated calls, etc.

The foregoing example implementation may have various benefits and advantages. For example, generation of various propensity outcomes associated with forecasts and predictive analytics to improve or reduce employee turnover for employers, provide financial recommendations catered to individual client/employee based on associated client/employee profile or data. In addition, real time financial behavioral changes are tracked and monitored to provide forecasts and predictive analytics that reflect on the changes.

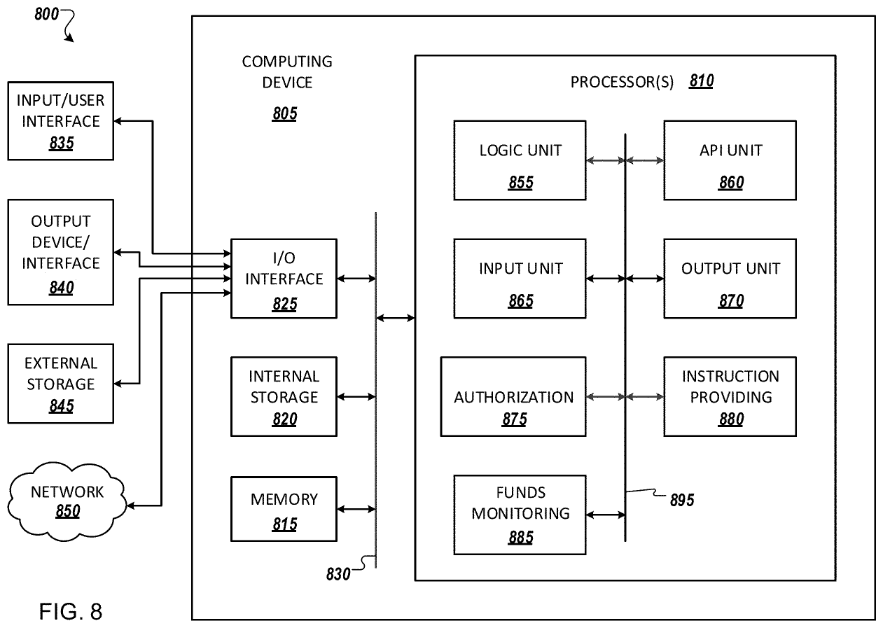

FIG. 8 illustrates an example computing environment 800 with an example computer device 805 suitable for use in some example implementations. Computing device 805 in computing environment 800 can include one or more processing units, cores, or processors 810, memory 815 (e.g., RAM, ROM, and/or the like), internal storage 820 (e.g., magnetic, optical, solid state storage, and/or organic), and/or I/O interface 825, any of which can be coupled on a communication mechanism or bus 830 for communicating information or embedded in the computing device 805.

Computing device 805 can be communicatively coupled to input/interface 835 and output device/interface 840. Either one or both of input/interface 835 and output device/interface 840 can be a wired or wireless interface and can be detachable. Input/interface 835 may include any device, component, sensor, or interface, physical or virtual, which can be used to provide input (e.g., buttons, touch-screen interface, keyboard, a pointing/cursor control, microphone, camera, braille, motion sensor, optical reader, and/or the like).

Output device/interface 840 may include a display, television, monitor, printer, speaker, braille, or the like. In some example implementations, input/interface 835 (e.g., user interface) and output device/interface 840 can be embedded with, or physically coupled to, the computing device 805. In other example implementations, other computing devices may function as, or provide the functions of, an input/interface 835 and output device/interface 840 for a computing device 805. These elements may include, but are not limited to, well-known AR hardware inputs so as to permit a user to interact with an AR environment.

Examples of computing device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 805 can be communicatively coupled (e.g., via I/O interface 825) to external storage 845 and network 850 for communicating with any number of networked components, devices, and systems, including one or more computing devices of the same or different configuration. Computing device 805 or any connected computing device can be functioning as, providing services of, or referred to as a server, client, thin server, general machine, special-purpose machine, or another label.

I/O interface 825 can include, but is not limited to, wired and/or wireless interfaces using any communication or I/O protocols or standards (e.g., Ethernet, 802.11xs, Universal System Bus, WiMAX, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computing device 805 can use and/or communicate using computer-usable or computer-readable media, including transitory media and non-transitory media. Transitory media includes transmission media (e.g., metal cables, fiber optics), signals, carrier waves, and the like. Non-transitory media includes magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 810 can execute under any operating system (OS) (not shown), in a native or virtual environment. One or more applications can be deployed that include logic unit 855, application programming interface (API) unit 860, input unit 865, output unit 870, context authorization unit 875, instruction providing unit 880, funds monitoring unit 885, and inter-unit communication mechanism 895 for the different units to communicate with each other, with the OS, and with other applications (not shown).

Processor(s) 810 can be configured to receive internal data on a client, the internal data comprises transactional data, behavioral data, demographic data, credit data, and communication data as illustrated in FIGS. 6-7. The processor(s) 810 may also be configured to receive external data, the external data comprises publicly available data as illustrated in FIGS. 6-7. The processor(s) 810 may also be configured to train the machine learning model using historical financial data to model forecasts and predictive analytics as illustrated in FIGS. 6-7. The processor(s) 810 may also be configured to deploy the trained machine learning model and providing the internal data and the external data as data input to the trained machine learning model as illustrated in FIGS. 6-7. The processor(s) 810 may also be configured to generate the financial propensity outcomes associated with the client from the trained machine learning model through forecasts and predictive analytics as illustrated in FIGS. 6-7.

The processor(s) 810 may also be configured to visualize the behavioral data in time series to identify key metric and insights as illustrated in FIGS. 6-7. The processor(s) 810 may also be configured to compare the visualized behavioral data against past behavioral data observed in prior time periods to identify data inconsistencies and sudden behavioral changes as illustrated in FIGS. 6-7.

For example, authorization unit 875, instruction providing unit 880, and funds monitoring unit 885 may implement one or more processes or data flows shown in FIGS. 1-5 above. The described units and elements can be varied in design, function, configuration, or implementation and are not limited to the descriptions provided.

In some example implementations, when information or an execution instruction is received by API unit 860, it may be communicated to one or more other units (e.g., authorization unit 875, instruction providing unit 880, and funds monitoring unit 885). For example, authorization unit 875 may collect, store, and update authorizations received from employers, employees and partners. Further, the funds monitoring unit 885 may detect funds received from the employer and inform the instruction providing unit 880. The instruction providing unit 880 may generate instructions and send them to custodial bank based on the stored authorizations collected and updated by the authorization unit. As the instruction providing unit 880 provides instructions to custodial bank, the funds monitoring unit 885 may continue to monitor the funds to determine when distribution and allocation has been completed, and in the event of any remainders in an employee's custody account after all allocations have been completed, instruct the remainder funds be transferred to the respective employee's personal bank account.

In some instances, the logic unit 855 may be configured to control the information flow among the units and direct the services provided by API unit 860, input unit 865, authorization unit 875, instruction providing unit 880, and funds monitoring unit 885 in some example implementations described above. For example, the flow of one or more processes or implementations may be controlled by logic unit 855 alone or in conjunction with API unit 860.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

We claim:

1. A method for generating financial propensity outcomes using a machine learning model, the method comprising:
receiving internal data on a client, the internal data comprises transactional data, behavioral data, demographic data, credit data, and communication data;
receiving external data, the external data comprises publicly available data;
training the machine learning model using historical financial data to model forecasts and predictive analytics;
deploying the trained machine learning model and providing the internal data and the external data as data input to the trained machine learning model; and
generating the financial propensity outcomes associated with the client from the trained machine learning model through forecasts and predictive analytics.

2. The method of claim 1, further comprising:
visualizing the behavioral data in time series to identify key metrics and insights; and
comparing the visualized behavioral data against past behavioral data observed in prior time periods to identify data inconsistencies and sudden behavioral changes.

3. The method of claim 1, wherein the financial propensity outcomes comprise turnover, engagement, savings, and next best options.

4. The method of claim 3, wherein the next best options comprise provision of at least one of at least one financial recommendation or at least one financial assistance option to assist the client's financials based on the data input.

5. The method of claim 3, wherein the engagement estimates an amount of time that the client engages a financial specialist or financial assistant for service provision.

6. The method of claim 3, wherein the turnover estimates the likelihood of the client leaving an employer based on the internal data.

7. A non-transitory computer readable medium, storing instructions for generating financial propensity outcomes using a machine learning model, the instructions comprising:
receiving internal data on a client, the internal data comprises transactional data, behavioral data, demographic data, credit data, and communication data;
receiving external data, the external data comprises publicly available data;
training the machine learning model using historical financial data to model forecasts and predictive analytics;
deploying the trained machine learning model and providing the internal data and the external data as data input to the trained machine learning model; and
generating the financial propensity outcomes associated with the client from the trained machine learning model through forecasts and predictive analytics.

8. The non-transitory computer readable medium of claim 7, further comprising:
visualizing the behavioral data in time series to identify key metrics and insights; and
comparing the visualized behavioral data against past behavioral data observed in prior time periods to identify data inconsistencies and sudden behavioral changes.

9. The non-transitory computer readable medium of claim 7, wherein the financial propensity outcomes comprise turnover, engagement, savings, and next best options.

10. The non-transitory computer readable medium of claim 9, wherein the next best options comprise provision of at least one of at least one financial recommendation or at least one financial assistance option to assist the client's financials based on the data input.

11. The non-transitory computer readable medium of claim 9, wherein the engagement estimates an amount of time that the client engages a financial specialist or financial assistant for service provision.

12. The non-transitory computer readable medium of claim 9, wherein the turnover estimates the likelihood of the client leaving an employer based on the internal data.
